(19) United States
(12) Patent Application Publication
(10) Pub. No.: US 2008/0153959 A1
(43) Pub. Date: Jun. 26, 2008

(54) Thermally Conducting and Electrically Insulating Moldable Compositions and Methods of Manufacture Thereof

(75) Inventors: Sanjay Gurabasappa Charati, Bangalore (IN); Soumyadeb Ghosh, Kundanhalli Bangalore (IN); Manjunath HR, Bangalor-Karnataka (IN); Jennifer Su Saak, Maple Glen, PA (US); Kunj Tandon, Bangalore Karnataka (IN)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/689,228

(22) Filed: Mar. 21, 2007

Related U.S. Application Data
(60) Provisional application No. 60/870,941, filed on Dec. 20, 2006.

(51) Int. Cl. C08K 3/00; B29B 7/00

(52) U.S. Cl. 524/404; 264/328.1; 428/402

(57) ABSTRACT

Disclosed herein is a moldable composition, comprising an organic polymer; a filler composition comprising graphite; and boron nitride, wherein the moldable composition has an electrical resistivity greater than or equal to about 10¹³ ohm/sq, wherein the moldable composition has a melt flow index of about 1 to about 30 grams per 10 minutes when measured at a temperature of 280° C. under a load of 16 kgf/cm². Disclosed herein too is a moldable composition, comprising about 30 to about 85 wt % of an organic polymer; a filler composition, comprising about 10 to about 70 wt % graphite; about 5 to about 60 wt % boron nitride; wherein the moldable composition has a thermal conductivity of about 2 to about 6 Watts per meter-Kelvin; and an electrical resistivity greater than or equal to about 10¹³ ohm/sq.

### CROSS-REFERENCE TO RELATED APPLICATIONS

This application claims the benefit of U.S. Patent Application Serial No. 60/870,941, filed Dec. 20, 2006, which is incorporated by reference herein in its entirety.

### BACKGROUND

This disclosure relates to moldable compositions that are thermally conducting and electrically insulating and methods of manufacture thereof.

Commercially available thermally conducting, moldable compositions are generally filled with thermally conducting fillers such as alumina or boron nitride. Alumina, however, is abrasive in nature and damages processing equipment. In addition, the low density of alumina makes the incorporation of adequate quantities of alumina difficult.

Boron nitride is also used as filler in thermally conductive moldable compositions. Boron nitride is costly and reduces the melt flow of the composition thereby making processing expensive. It is therefore desirable to find filler compositions for thermally conducting moldable compositions that are inexpensive, that improve melt flow during processing, and that produce compositions having a suitable balance of mechanical and thermal properties.

### SUMMARY

Disclosed herein is a moldable composition, comprising an organic polymer; a filler composition comprising graphite; and boron nitride, wherein the moldable composition has an electrical resistivity greater than or equal to about 10¹³ ohm/sq, wherein the moldable composition has a melt flow index of about 1 to about 30 grams per 10 minutes when measured at a temperature of 280° C. under a load of 16 kgf/cm².

Disclosed herein too is a moldable composition, comprising about 30 to about 85 wt % of an organic polymer; a filler composition, comprising about 10 to about 30 wt % graphite; about 5 to about 60 wt % boron nitride; wherein the moldable composition has a thermal conductivity of about 2 to about 6 Watts per meter-Kelvin; and an electrical resistivity greater than or equal to about 10¹³ ohm/sq.

Disclosed herein too is a method of manufacturing a moldable composition comprising melt blending a moldable composition comprising an organic polymer; a filler composition comprising graphite, and boron nitride, wherein the moldable composition has an electrical resistivity greater than or equal to about 10¹³ ohm/sq.

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Disclosed herein is a moldable composition that is thermally conducting, and electrically insulating. The moldable composition comprises an organic polymer, and a filler composition comprising graphite and boron nitride, wherein the moldable composition has a bulk surface resistivity greater than or equal to about 10¹³ ohm/sq, while displaying a thermal conductivity greater than or equal to about 2 W/m-K. The moldable composition displays a melt flow index of about 1 to about 30 grams per 10 minutes at a temperature of 280° C. and a load of 16 kg-f/cm² and can therefore be easily processed. The moldable composition can be advantageously molded into desirable shapes and forms, and can have a class A surface finish.

The organic polymer used in the moldable composition may be selected from a wide variety of thermoplastic resins, blend of thermoplastic resins, thermosetting resins, or blends of thermoplastic resins with thermosetting resins. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, or the like, or a combination comprising at last one of the foregoing organic polymers. Examples of the organic polymer are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene propylene diene rubber (EPR), polytetrafluoroethylene, fluorinated ethylene propylene, perfluoroalkoxyethylene, polychlorotrifluoroethylene, polyvinylidene fluoride, or the like, or a combination comprising at least one of the foregoing organic polymers.

Examples of blends of thermoplastic resins include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like.

Examples of thermosetting resins include polyurethane, natural rubber, synthetic rubber, epoxy, phenolic, polyesters, polyamides, silicones, or the like, or a combination comprising at least one of the foregoing thermosetting resins. Blends of thermoset resins as well as blends of thermoplastic resins with thermosets can be utilized.

The organic polymer is generally used in amounts of about 10 to about 85 weight percent (wt %), of the total weight of the moldable composition. The organic polymer is generally used in amounts of greater than or equal to about 33, specifically greater than or equal to about 35, and more specifically greater than or equal to about 40 wt %, of the total weight of the moldable composition. The organic polymer is furthermore generally used in amounts of less than or equal to about 80, specifically less than or equal to about 75, and more specifically less than or equal to about 70 wt %, of the total weight of the moldable composition.

The filler composition used in the moldable composition comprises graphite and boron nitride. Graphite employed in the moldable composition may be synthetically produced or naturally produced. It is desirable to use graphite that is naturally produced. There are three types of naturally produced graphite that are commercially available. They are flake graphite, amorphous graphite and crystal vein graphite.

Flake graphite, as indicated by the name, has a flaky morphology. Amorphous graphite is not truly amorphous as its name suggests but is actually crystalline. Amorphous graphite is available in average sizes of about 5 micrometers to about 10 centimeters. Crystal vein graphite generally has a vein like appearance on its outer surface from which it derives its name. Crystal vein graphite is commercially available in the form of flakes from Asbury Graphite and Carbon Inc Carbons.

Synthetic graphite can be produced from coke and/or pitch that are derived from petroleum or coal. Synthetic graphite is of higher purity than natural graphite, but not as crystalline. One type of synthetic graphite is electrographite, which is produced from calcined petroleum coke and coal tar pitch in an electric furnace. Another type of synthetic graphite is produced by heating calcined petroleum pitch to 2800° C. Synthetic graphite tends to be of a lower density, higher porosity, and higher electrical resistance than natural graphite.

It is desirable to use graphite having average particle sizes of about 1 to about 5,000 micrometers. Within this range graphite particles having sizes of greater than or equal to about 3, specifically greater than or equal to about 5 micrometers may be advantageously used. Also desirable are graphite particles having sizes of less than or equal to about 4,000, specifically less than or equal to about 3,000, and more specifically less than or equal to about 2,000 micrometers. Graphite is generally flake like with an aspect ratio greater than or equal to about 2, specifically greater than or equal to about 5, more specifically greater than or equal to about 10, and even more specifically greater than or equal to about 50.

Graphite is generally used in amounts of greater than or equal to about 10 wt % to about 30 wt % of the total weight of the moldable composition. Within this range, graphite is generally used in amounts greater than or equal to about 13 wt %, specifically greater or equal to about 14 wt %, more specifically greater than or equal to about 15 wt % of the total weight of the moldable composition. Graphite is furthermore generally used in amounts less than or equal to about 28 wt %, specifically less than or equal to about 26 wt %, more specifically less than or equal to about 25 wt % of the total weight of the moldable composition.

Boron nitride may be cubic boron nitride, hexagonal boron nitride, amorphous boron nitride, rhombohedral boron nitride, or another allotrope. It may be used as powder, agglomerates, or fibers.

Boron nitride has an average particle size of about 1 to about 5,000 micrometers. Within this range boron nitride particles having sizes of greater than or equal to about 3, specifically greater than or equal to about 5 micrometers may be advantageously used. Also desirable are boron nitride particles having sizes of less than or equal to about 4,000, specifically less than or equal to about 3,000, and more specifically less than or equal to about 2,000 micrometers. Boron nitride is generally flake like with an aspect ratio greater than or equal to about 2, specifically greater than or equal to about 5, more specifically greater than or equal to about 10, and even more specifically greater than or equal to about 50. An exemplary particle size is about 125 to about 300 micrometers with a crystal size of about 10 to about 15 micrometers. The boron nitride particles can exist in the form of agglomerates or as individual particles or as combinations of individual particles and agglomerates. Exemplary boron nitrides are PT350, PT360 or PT 370, commercially available from General Electric Advanced Materials

Boron nitride is generally used in amounts of about 5 wt % to about 60 wt % of the total weight of the moldable composition. Within this range, boron nitride is generally used in amounts greater than or equal to about 8 wt %, specifically greater or equal to about 10 wt %, more specifically greater than or equal to about 12 wt % of the total weight of the moldable composition. Boron nitride is furthermore generally used in amounts less than or equal to about 55 wt %, specifically less than or equal to about 50 wt %, more specifically less than or equal to about 45 wt % of the total weight of the moldable composition. An exemplary amount of boron nitride is about 15 to about 40 wt % of the total weight of the moldable composition.

Additionally, the moldable composition may optionally also contain additives such as antioxidants, such as, for example, organophosphites, for example, tris(nonyl-phenyl)phosphite, tris(2,4-di-t-butylphenyl)phosphite, bis(2,4-di-t-butylphenyl)pentaerythritol diphosphite or distearyl pentaerythritol diphosphite, allcylated monophenols, polyphenols and alkylated reaction products of polyphenols with dienes, such as, for example, tetrakis[methylene(3,5-di-tert-butyl-4-hydroxyhydrocinnamate)]methane, 3,5-di-tert-butyl-4-hydroxyhydrocinnamate, octadecyl 2,4-di-tert-butylphenyl phosphite, butylated reaction products of para-cresol and dicyclopentadiene, alkylated hydroquinones, hydroxylated thiodiphenyl ethers, alkylidene-bisphenols, benzyl compounds, esters of beta-(3,5-di-tert-butyl-4-hydroxyphenyl)-propionic acid with monohydric or polyhydric alcohols, esters of beta-(5-tert-butyl-4-hydroxy-3-methylphenyl)-propionic acid with monohydric or polyhydric alcohols; esters of thioalkyl or thioaryl compounds, such as, for example, distearylthiopropionate, dilaurylthiopropionate, ditridecylthiodipropionate, amides of beta-(3,5-di-tert-butyl-4-hydroxyphenyl)-propionic acid; fillers and reinforcing agents, such as, for example, silicates, titanium dioxide (TiO₂), calcium carbonate, talc, mica and other additives such as, for example, mold release agents, ultraviolet absorbers, stabilizers such as light stabilizers and others, lubricants, plasticizers, pigments, dyes, colorants, anti-static agents, blowing agents, flame retardants, impact modifiers, among others, as well as combinations comprising at least one of the foregoing additives.

The organic polymer together with graphite and boron nitride may generally be processed in several different ways such as, melt blending, solution blending, or the like, or combinations comprising at least one of the foregoing methods of blending. Melt blending of the moldable composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing.

Melt blending involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or the like, or combinations comprising at least one of the foregoing machines.

In one embodiment, the organic polymer in powder form, pellet form, sheet form, or the like, may be first dry blended with graphite and boron nitride in a Henschel or in a roll mill, prior to being fed into a melt blending device such as an extruder or Buss kneader. It may be desirable to introduce graphite, boron nitride, or a combination of graphite and boron nitride into the melt blending device in the form of a masterbatch. In such a process, the masterbatch may be introduced into the melt blending device downstream of the point where the organic polymer is introduced.

A melt blend is one where at least a portion of the organic polymer has reached a temperature greater than or equal to about the melting temperature, if the resin is a semi-crystalline organic polymer, or the flow point (e.g., the glass transition temperature) if the resin is an amorphous resin during the blending process. A dry blend is one where the entire mass of organic polymer is at a temperature less than or equal to about the melting temperature if the resin is a semi-crystalline organic polymer, or at a temperature less than or equal to the flow point if the organic polymer is an amorphous resin and wherein organic polymer is substantially free of any liquid-like fluid during the blending process. A solution blend, as defined herein, is one where the organic polymer is suspended in a liquid-like fluid such as, for example, a solvent or a non-solvent during the blending process.

The moldable composition comprising the organic polymer and graphite and boron nitride may be subject to multiple blending and forming steps if desirable. For example, the moldable composition may first be extruded and formed into pellets. The pellets may then be fed into a molding machine where it may be formed into any desirable shape or product. Alternatively, the moldable composition emanating from a single melt blender may be formed into sheets or strands and subjected to post-extrusion processes such as annealing, uniaxial or biaxial orientation.

Solution blending may also be used to manufacture the moldable composition. The solution blending may also use additional energy such as shear, compression, ultrasonic vibration, or the like, to promote homogenization of graphite and boron nitride with the organic polymer. In one embodiment, an organic polymer suspended in a fluid may be introduced into an ultrasonic sonicator along with graphite and boron nitride. The mixture may be solution blended by sonication for a time period effective to disperse graphite and boron nitride onto the organic polymer particles. The organic polymer along with graphite and boron nitride may then be dried, extruded and molded if desired. It is generally desirable for the fluid to swell the organic polymer during the process of sonication. Swelling the organic polymer generally improves the ability of graphite and boron nitride to impregnate the organic polymer during the solution blending process and consequently improves dispersion.

The moldable composition displays advantageous melt flow properties. In one embodiment, the moldable composition has a melt flow index of about 1 to about 30 grams per 10 minutes when measured at a temperature of 280° C. under a load of 16 kg-f/cm². An exemplary melt flow index for the moldable composition is about 4 to about 20 grams per 10 minutes when measured at a temperature of 280° C. under a load of 16 kg-f/cm².

In one embodiment, the moldable composition comprises a random distribution of graphite and boron nitride and has a thermal conductivity of greater than 2 Watts per meter-Kelvin (W/m-K). In another embodiment, the moldable composition generally has a thermal conductivity of about 2 to about 6 W/m-K. Within this range, it is generally desirable for the moldable composition to have a thermal conductivity greater than or equal to about 2.2 W/m-K, specifically greater or equal to about 2.3 W/m-K, more specifically greater than or equal to about 2.4 W/m-K. Also desirable is for the moldable composition to have a thermal conductivity less than or equal to about 4.0 W/m-K, specifically less than or equal to about 3.9 W/m-K, more specifically less than or equal to about 3.8 W/m-K.

The moldable composition is electrically insulating. In one embodiment, the moldable composition has an electrical resistivity greater than or equal to about 10¹³ ohm/sq.

The invention is further illustrated by the following non-limiting examples.

### EXAMPLES

### Examples 1-9

These examples demonstrate the improved thermal conductivity and the improved melt flow of the moldable compositions disclosed herein over comparative compositions that contain only boron nitride. The examples of this disclosure are all electrically insulating. Examples #1, 8 and 9 are comparative examples, while Example #'s 2-7 are representative of the moldable compositions of this disclosure.

Boron nitride (BN) agglomerates, commercially available as PT-360, were supplied by General Electric Advanced Ceramic Corporation. Crystal Vein Graphite (C) was supplied by Asbury Graphite and Carbon Inc. The polyamide (PA) used was Nylon-6. Polypropylene (PP) added to improve the melt flow. Graphite and boron nitride were dry-mixed with the polyamide and polypropylene, and then fed through the main feeder of the extruder.

The moldable compositions were prepared using a 25 millimeter Werner and Pfleiderer twin-screw extruder. The extruder had 6 barrels set at temperatures of 23, 230, 240, 250, 260 and 270° C. from the throat to the die respectively. The die was set at 280° C. Pellets obtained from the extruder were subjected to injection molding in a Larsen and Toubro injection molding machine.

The thermal conductivity measurements, electrical conductivity measurements, and melt flow indices for different moldable compositions are presented in Table 1. Thermal conductivity measurements were made using a laser flash and a probe method. A Netzsch™ Nanoflash instrument was used to conducted the laser flash testing according to ASTM standard E1461. Test specimen dimensions for the laser flash were 3 mm thick×12.5 mm diameter for the Example #'s 1-9. Thermal conductivity (TC) was measured using an Elmer Pyris thermal conductivity probe, and is reported in Watts per Kelvin-meter (W/m-K). All measurements were conducted at room temperature on injection molded plaques.

Surface resistivity testing was conducted using ASTM D257 as a guide. The test specimens were about 3 mm thick×50 mm in diameter. Samples are conditioned at 23° C. and 50% relative humidity for 40 hours before testing. Amounts are reported in weight percent based on the total weight of the total moldable composition.

TABLE 1

| | | | | | | Average | Std. Dev. | Viscosity | Decrease | |
|---|---|---|---|---|---|---|---|---|---|---|
| | | | | | Surface | Thermal | Thermal | (Pa-sec, at | in | |
| Example | C* | BN* | PA | PP | Resistivity | Conductivity | Conductivity | 4000 l/s, | Viscosity | MFI |
| No. | (wt %) | (wt %) | (wt %) | (wt %) | (ohm/sq) | (W/m-K) | (W/m-K) | 255 C.) | (%) | (g/10 min) |
| 1¹ | 0 | 71 | 26 | 3 | 2.8E+14 | 2.2 | 0.7 | 240 | n/a | no flow |
| 2 | 13 | 58 | 26 | 3 | 1.9E+13 | 3.3 | 0.2 | 177 | 26 | 2.7 |
| 3 | 17 | 54 | 26 | 3 | 3.9E+13 | 3.2 | 0.2 | 161 | 33 | 14.7 |
| 4 | 20 | 51 | 26 | 3 | 2.0E+13 | 3.4 | 0.2 | 134 | 44 | N/A |
| 5 | 22 | 49 | 26 | 3 | 3.0E+13 | 3.2 | 0.2 | 139 | 42 | 9.7 |
| 6 | 26 | 45 | 26 | 3 | 3.8E+13 | 3.6 | 0.3 | 170 | 29 | 4.0 |
| 7 | 30.1 | 40.8 | 26 | 3 | 1.2E+13 | 4.0 | 0.3 | 181 | 25 | N/A |
| 8¹ | 32.7 | 38.2 | 26 | 3 | 2.9E+06 | 4.1 | 0.3 | 189 | 21 | 5.8 |
| 9¹ | 35.3 | 35.6 | 26 | 3 | 5.0E+06 | 3.8 | 0.1 | 212 | 12 | N/A |

¹= comparative example
*= the combined volume loading of carbon and boron nitride for examples 1 through 9 was 55 volume percent.

The data in Table 1 compares the thermal, electrical, and Theological properties of various mixed filler compositions (Example #'s 2-9) compared with the pure BN filled composition (Example #1). The graphite used in all these examples is crystal vein graphite (CVG). As can be seen in the Table 1, an increase of about 50% in thermal conductivity is achieved by adding about 13 wt % of graphite; the overall thermal conductivity increases from 2.2 to 3.3 W/m-K with this addition. In summary, the results indicate that the addition of graphite and boron nitride improves the thermal conductivity of moldable compositions over comparative compositions containing only boron nitride.

The surface resistivity results shown in Table 1 indicate that the electrical percolation threshold for graphite, in these dual-filled materials, is achieved in Example 7 that contains 30 wt % graphite. All mixed filler examples containing up to about 30 wt % graphite were electrically insulating with a surface resistivity of E+13 ohm/sq. The materials become statically dissipative with a resistivity of E+6 ohm/sq with increased graphite loadings. The compositions also showed excellent insulative properties at high voltages. The composition containing 22 wt % CVG-graphite (Example # 5) was found to have a CTI (Comparative tracking index) greater than 600 volts (i.e., no failure up to 600 V, the highest voltage that can be applied by the instrument) when measured as per IEC112/ASTM D 6368.

The replacement of some of the boron nitride with a lubricious material such as graphite increases the melt flow of the material. This is shown by the viscosity and melt flow index (MFI) data in Table 1 where the viscosity at a shear rate of 4000 seconds⁻¹ is listed. A reduction in viscosity is tabulated based on a comparison between that of the comparative sample (Example 1) to that of each graphite/BN material (Example 2-9). The data shows that the maximum reduction in viscosity, 44%, is achieved using 20 to 22 wt % graphite (Example 4 and 5). However, higher and lower levels of graphite addition still provide a significant improvement in melt flow, and thus improve the processability by injection molding.

### Examples 10-11

This set of experiments was performed to show the advantages of mixed filler systems of graphite and boron nitride versus filler systems that comprise only boron nitride in other resin systems. Sample #'s 10-11 contain 45 volume percent (vol %) of the filler composition. These samples were manufactured in a manner similar to the Example #'s 1-9. Example #'s 10 and 11 contain PC/ABS (polycarbonate-acrylonitrile butadiene styrene blend) that is commercially obtained from the General Electric Company. The composition and the results for thermal conductivity and melt flow index are shown in the Table 2.

TABLE 2

| | | | | Average | Std. Dev. | |
|---|---|---|---|---|---|---|
| | | | | Thermal | Thermal | |
| | | | PC/ | Conduc- | Conduc- | MFI |
| Example | C | BN | ABS | tivity | tivity | (g/10 |
| No. | (Vol %) | (Vol %) | (Vol %) | (W/m-K) | (W/m-K) | min) |
| 10 | 0 | 45 | 55 | too viscous to injection mold | | |
| 11 | 17 | 28 | 55 | 2.0 | 1.7 | 16 |

With the addition of 17 vol % graphite, a compound that was otherwise too viscous to flow (Example 10), became injection moldable with a melt flow index of 16 grams/10 minutes (Example 11).

### Example 12-14

These examples were conducted to demonstrate the effects of different types of graphite on thermal conductivity. Table 3 shows thermal and Theological data from three different types of graphite. These samples were manufactured in a manner similar to the Example #'s 1-9. Crystal vein graphite (CVG) graphite, which was used in the previous examples, is compared to natural graphite and synthetic graphite. CVG has the highest aspect ratio as compared with the other two. The polymeric resin comprised 90 wt % Nylon-6 and 10 wt % polypropylene, based on the weight of the polymeric resin.

TABLE 3

| | | | | Average | Std. Dev. | |
|---|---|---|---|---|---|---|
| | | | | Thermal | Thermal | |
| Ex- | | | | Conduc- | Conduc- | MFI |
| ample | Carbon | C | BN | tivity | tivity | (g/10 |
| No. | Types | (wt %) | (wt %) | (W/m-K) | (W/m-K) | min) |
| 12 | Graphite - | 22 | 49 | 3.0 | 0.2 | 9.7 |
| | CVG | | | | | |
| 13 | Graphite - | 22 | 49 | 3.5 | 0.2 | 2.7 |
| | natural | | | | | |
| 14 | Graphite - | 22 | 49 | 2.7 | 0.6 | No flow |
| | synthetic | | | | | |

The data indicates that CVG provides the best enhancement in flow. Natural graphite shows a moderate improvement, while synthetic graphite/BN compounds did not flow. All three compositions were electrically insulating. Thus, CVG graphite is the preferred carbon based filler for the aforementioned filler compositions.

### Examples 15-17

These examples were conducted to show the effect of the addition of other carbonaceous fillers to a composition comprising the organic polymer and the boron nitride. The other carbonaceous fillers selected for the examples were carbon fibers, multiwall carbon nanotubes (MWNTs) or carbon black. No graphite was added to the samples. The compositions along with the results are shown in the Table 4. These samples were manufactured in a manner similar to that described in the Examples #'s 1-9. While Table 4 shows the values of the carbonaceous and the boron nitride fillers, the remaining parts of the composition were a polymeric resin. The polymeric resin comprised 90 wt % Nylon-6 and 10 wt % polypropylene, based on the weight of the polymeric resin.

TABLE 4

| | | | | Average | Std. Dev. |
|---|---|---|---|---|---|
| | | | | Thermal | Thermal |
| Example | Carbon | C | | Conductivity | Conductivity |
| No. | Types | (vol %) | BN (vol %) | (W/m-K) | (W/m-K) |
| 15 | carbon | 4.8 | 51 | 1.3 | 0.2 |
| | fiber | | | | |
| 16 | MWNT | 2.9 | 52 | 2.0 | 0.2 |
| 17 | carbon | 10.3 | 45 | 1.9 | 0.6 |
| | black | | | | |
| 18 | carbon | 7.8 | 48 | 1.8 | 0.22 |
| | fiber | | | | |
| 19 | MWNT | 3 | 52 | 3.0 | 0.60 |

As can be seen in the Table 4, the compositions containing carbon fibers, multi-wall nanotubes (MWNT), and carbon black, did not exhibit the enhanced thermal conductivity seen in the Examples 2-7 that used graphite in conjunction with boron nitride. All of the Examples 15-19 were electrically insulating and were too viscous to make a determination of the melt flow index. The use of carbon black, which is spherical in shape, actually decreased the thermal conductivity as well. Thus, graphite is the preferred carbon-based filler for improvements in thermal conductivity as-well as melt flow and processability.

### Example 20

This example was conducted to demonstrate the lack of a synergy between graphite and other thermally conductive materials such alumina (Al₂O₃). Table 5 shows a composition having CVG graphite with alumina. Example 20 that is represented in the Table 5 can be compared with Example 5 in the Table 1. Both samples contain 17 volume percent of graphite. The balance of the composition is a polymer. The polymeric resin comprised 90 wt % Nylon-6 and 10 wt % polypropylene, based on the weight of the polymeric resin. However, as can be seen from the Table 5, the sample is electrically conducting.

TABLE 5

| | | | Average | Std. Dev. | |
|---|---|---|---|---|---|
| | | | Thermal | Thermal | Volume |
| Example | | Al₂O₃ | Conductivity | Conductivity | Resistivity |
| No. | C (vol %) | (vol %) | (W/m-K) | (W/m-K) | (ohm-cm) |
| 20 | 17 | 38 | 2.6 | 0.08 | 80 |

Thus from the above examples, it can be seen that a combination of graphite and boron nitride in the moldable composition yields samples that are electrically insulating, but have a high thermal conductivity and are easily processable.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A moldable composition, comprising:
an organic polymer;
a filler composition comprising:
graphite; and
boron nitride, wherein the moldable composition has an electrical resistivity greater than or equal to about 10¹³ ohm/sq, wherein the moldable composition has a melt flow index of about 1 to about 30 grams per 10 minutes when measured at a temperature of 280° C. under a load of 16 kgf/cm².

2. The moldable composition of claim 1, having a thermal conductivity of about 2 W/m-K to about 6 W/m-K.

3. The moldable composition of claim 1, having a Class A surface finish.

4. The moldable composition of claim 1, wherein the organic polymer is a thermoplastic resin, a blend of thermoplastic resins, a thermosetting resin, a blend of thermosetting resins, a blend of thermoplastic resins with thermosetting resins, a copolymer, a terpolymer, an oligomer, a homopolymer, a block copolymer, an alternating block copolymer, a random copolymer, a random block copolymer, a graft copolymer, a star block copolymer, a dendrimer, or a combination comprising at least one of the foregoing organic polymers.

5. The moldable composition of claim 1, wherein said organic polymer is a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, polysulfonate, a polysulfide, a polythioester, a polysulfone, a polysulfonamide, polyurea, a polyphosphazene, a polysilazane, a styrene acrylonitrile, a acrylonitrile-butadiene-styrene, or a combination comprising at least one of the foregoing polymers.

6. The moldable composition of claim 1, wherein the organic polymer is a thermosetting resin and wherein the thermosetting resins are polyurethanes, natural rubbers, synthetic rubbers, epoxies, phenolics, silicones, or a combination comprising at least one of the foregoing polymers.

7. The moldable composition of claim 1, wherein the graphite is a crystal vein graphite, a flake graphite, an amorphous graphite, a synthetic graphite, or a combination comprising at least one of the foregoing graphites.

8. The moldable composition of claim 7, wherein the graphite has a particle size of about 1 to about 5000 micrometers.

9. The moldable composition of claim 1, wherein the graphite is present in an amount of 10 wt % to about 30 wt % based on the weight of the moldable composition.

10. The moldable composition of claim 1, wherein the boron nitride is a cubic boron nitride, a hexagonal boron nitride, an amorphous boron nitride, a rhombohedral boron nitride, or a combination comprising at least one of the boron nitrides.

11. The moldable composition of claim 10, wherein the boron nitride has a particle size of about 1 to about 5,000 micrometers.

12. The moldable composition of claim 1, wherein the boron nitride is present in an amount of 5 wt % to about 60 wt % based on the weight of the moldable composition.

13. A moldable composition, comprising:
about 30 to about 85 wt % of an organic polymer composition; and
a filler composition, comprising:
about 10 to about 30 wt % graphite;
about 5 to about 60 wt % boron nitride; wherein all weights are based on the weight of the moldable composition; wherein the moldable composition has a thermal conductivity of about 2 to about 6 Watts per meter-Kelvin and an electrical resistivity greater than or equal to about 10¹³ ohm/sq.

14. The moldable composition of claim 13, wherein the melt flow index is about 1 to about 30 grams per 10 minutes when measured at a temperature of 280° C. under a load of 16 kg-f/cm².

15. A method of manufacturing a moldable composition comprising:
melt blending a moldable composition comprising an organic polymer; a filler composition comprising graphite; and boron nitride, wherein the moldable composition has an electrical resistivity greater than or equal to about 10¹³ ohm/sq.

16. The method of claim 15, further comprising molding the moldable composition.

17. The method of claim 15, wherein the molding is injection molding.

18. An article comprising the moldable composition of claim 1.

19. An article comprising the moldable composition of claim 15.

20. An article comprising the moldable composition of claim 17.
